(19) United States
(12) Patent Application Publication
(10) Pub. No.: US 2009/0205117 A1
(43) Pub. Date: Aug. 20, 2009

(54) PROTECTIVE GARMENT

(76) Inventors: Craig Jeremy Day, New South Wales (AU); Delia Therese Lannane, Barradel (AU)

Correspondence Address: KING & SCHICKLI, PLLC, 247 NORTH BROADWAY, LEXINGTON, KY, 40507, US

(21) Appl. No.: 11/573,526

(22) PCT Filed: Aug. 29, 2005
(86) PCT No.: PCT/AU05/01294

§ 371 Date: Oct. 27, 2008

(30) Foreign Application Priority Data
Aug. 31, 2004 (AU) 2004904965

(51) Int. Cl. A62B 17/00; A41D 3/08

(52) U.S. Cl. 2/457; 2/84

(57) ABSTRACT

A protective garment (10) which includes a front portion (12), a rear portion (14), arms (13, 15) and a hood (22), the front portion being a continuous panel which is free of openings. The rear portion is secured to our integral with the front portion and generally in two parts to enable the user to don the garment. There is provided fastenings (18) for holding the two parts together and the hood being connected to a neck section of the front and rear portions.

This invention relates generally to protective garments for protecting the user when handling hazardous materials such as chemicals and the like.

Known protective garments usually comprise a jacket and trousers or overalls. A disadvantage of such protective garments is that they can be difficult to put on and take off and as such there is a resistance to personnel using such garments.

It is an object of the present invention to provide an improved protective garment which alleviates the aforementioned difficulty.

According to one aspect of the present invention there is provided a protective garment which includes a front portion, a rear portion, arms and a hood. The front portion is in the form of an apron-like continuous panel which is free of openings. The rear portion is secured to or integral with the front portion and is generally in two parts to enable the user to don the garment. Fastenings are provided for holding the two parts together and the hood is connected to a neck section of the front and rear portions.

Preferably the arms and the hood are connected to the front and rear portions of the garment by seams which are sealed so as to inhibit the passage of materials and substances therethrough.

In one embodiment the fastenings may be in the form of Velcro™ strips. The fastenings may be provided at the neck portion and waist portion of the garment.

Preferably the garment has a lower edge which when the garment is worn by the user extends at least to below the knees of the user. Preferably where boots are used in association with the protective garment, the lower edge extends below the upper edge of the boots. For example, gum boots are often used with protective garments of this type.

In one form the hood may have an opening for receiving the face of the user the opening having an elasticised peripheral edge. The rear of the hood may include a strengthening peripheral edge tape such as twill tape.

The sleeves of the protective garment may include cuff portions having fold sections thereon with associated fasteners so that the cuffs can be tightened so as to closely fit the user's wrists. In another arrangement the cuffs may be tightened by straps thereon.

The material from which the garment is formed may be of any suitable type. Preferably the material is resistant to at least some chemicals. For example it may be a plastics material such as nylon or polyester and may have a coating applied thereto. The coating may be a hydrophilic type and/or a breathable membrane. An example of a particularly suitable material is sold by Fabri-Cell International Pty Ltd under the trade mark Breathalon.

A preferred embodiment of the invention will hereinafter be described with reference to the accompany drawings and in those drawings:

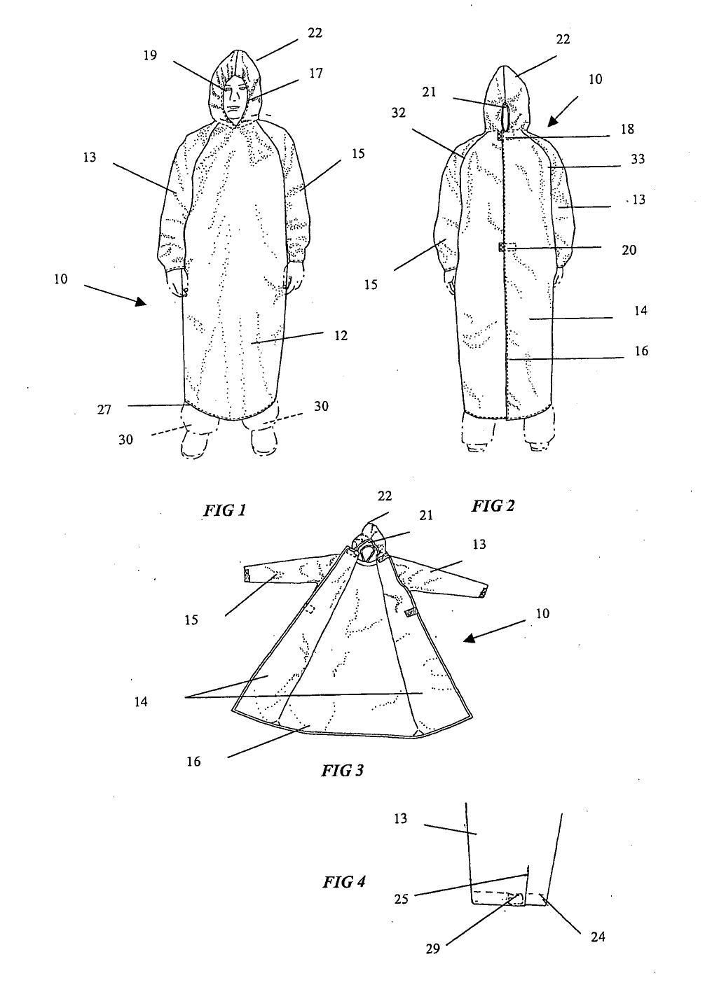

FIG. 1 is a schematic front view of the protective garment according to one embodiment of the invention;

FIG. 2 is a rear view of the protective garment show in FIG. 1;

FIG. 3 is a further rear view of the protection garment shown in FIG. 1; and

FIG. 4 is a schematic detail of a cuff portion of a sleeve of the protective garment shown in FIG. 1.

Referring to the drawings, there is shown a protective garment generally indicated at 10 which includes a front portion 12 in the form of an apron-like continuous panel, a rear portion 14 which includes two panel portions secured to the or integral to the front portion and having a longitudinally extending opening 16 having Velcro™ fasteners 18 and 20 for holding the opening closed. The garment further includes sleeves 13 and 15 and a hood 22 which is secured to the front and rear portions having an opening 17 in its front side for the face of the user. The edge portion 19 of the opening 17 in the hood 22 is elasticised so that it forms a close fit around the user's face. There is a rear aperture 21 where it joins the rear portion 14 which is reinforced with twill tape.

As shown in FIG. 4 cuffs 24 of the sleeves 13 and 15 include a foldable seam 25 and Velcro™ fastener 29 so that the tightness of the cuffs can be adjusted.

The lower edge 27 of the garment 10 extends below the upper level of the rubber boots 30 worn by the user. All seams such as these shown as 32, 33 and 34 are glued or welded. Any suitable material can be used for forming the garment as described earlier.

It will be appreciated that the garment can be donned by opening the rear portion 14 and passing the wearers arms into each of the sleeves 13 and 15 whereafter the rear portion opening can be closed and held by fasteners 18 and 20. The protective garment can be readily worn over other clothing and is very easily put on and taken off. The continuous front panel ensures that the wearer is protected when handling chemicals and other potentially dangerous substances.

Finally, it is to be understood that various alterations, modifications and/or additions may be incorporated into the various constructions and arrangements of parts without departing from the spirit or ambit of the invention.

1. A protective garment which includes a front portion, a rear portion, arms and a hood, the front portion being a continuous panel which is free of openings, the rear portion being secured to our integral with the front portion and generally in two parts to enable the user to don the garment, and fastenings for holding the two parts together the hood being connected to a neck section of the front and rear portions.

2. A protective garment according to claim 1 wherein the arms and the hood are connected to the front and rear portions of the garment by seams which are sealed so as to inhibit the passage of materials and substances there through.

3. A protective garment according to claim 1 or 2 wherein the fastenings include Velcro™ strips.

4. A protective garment according to claim 3 wherein the fastening are provided at the neck portion and waist portion of the garment.

5. A protective garment according to any proceeding claims for use with boots the garment having a lower edge which when the garment is worn by the user extends at least to below the knees of the user, and the lower edge extends below the upper edge of the boots.

6. A protective garment according to any proceeding claim wherein has an opening for receiving the face of the user the opening having an elasticised peripheral edge, and the rear of the hood includes a strengthening peripheral edge tape such as twill tape.

7. A protective garment according to any proceeding claim including sleeves having cuff portions with fold sections thereon with associated fasteners so that the cuffs can be tightened so as to closely fit the users wrists.

8. A protective garment according to any preceding claim wherein the garment is formed from a material which is resistant to at least some chemicals.
